(19) United States
(12) Patent Application Publication
(10) Pub. No.: US 2026/0303203 A1
(43) Pub. Date: Oct. 1, 2026

(54) INTERFERENCE MITIGATION FOR SATELLITE-BASED DIRECT TO CELLULAR COMMUNICATIONS

(71) Applicant: AT&T Intellectual Property I, L.P., Atlanta, GA (US)

(72) Inventors: Yupeng Jia, South Pasadena, CA (US); Hongyan Lei, Plano, TX (US)

(21) Appl. No.: 19/093,093

(22) Filed: Mar. 27, 2025

(51) Int. Cl. H04B 7/185; H04B 17/309

(52) U.S. Cl. CPC H04B 7/18543; H04B 7/1855; H04B 17/346

(57) ABSTRACT

A processing system of a communication satellite may obtain at least one communication from at least one of: a wireless endpoint device or a terrestrial cellular base station that indicates a presence of the terrestrial cellular base station. The processing system may next identify, based upon the at least one communication, that a first communication coverage zone of the terrestrial cellular base station is within a second communication coverage zone of the communication satellite. In addition, the processing system may determine, in response to identifying that the first communication coverage zone is within the second communication coverage zone, a potential interference between the communication satellite and the terrestrial cellular base station. The processing system may then apply a transmission beam coverage hole co-located with the first communication coverage zone, in response to the determining of the potential interference between the communication satellite and the terrestrial cellular base station.

The present disclosure relates generally to satellite access for cellular networks, and more particularly to methods, non-transitory computer-readable media, and apparatuses for a processing system of a communication satellite applying a transmission beam coverage hole co-located with a first communication coverage zone of a terrestrial cellular base station in response to determining a potential interference between the communication satellite and the terrestrial cellular base station.

### BACKGROUND

Modern society may increasingly expect continuous network connectivity at any time of the day and day of the week. In many cases, a loss of connectivity may be considered an emergency. For example, first responders, governmental entities, medical facilities, home medical devices, and others may rely on consistent connectivity in order to function. In addition, small cells and wireless access points are increasingly prevalent. However, wireless access points and small cells may still assume access is available to wired infrastructure capable of supporting high data rates, which may still remain infeasible in many areas of the world.

### SUMMARY

In one example, the present disclosure discloses a method, computer-readable medium, and apparatus for a processing system of a communication satellite applying a transmission beam coverage hole co-located with a first communication coverage zone of a terrestrial cellular base station in response to determining a potential interference between the communication satellite and the terrestrial cellular base station. For example, a processing system including at least one processor of a communication satellite may obtain at least one communication from at least one of a wireless endpoint device or a terrestrial cellular base station that indicates a presence of the terrestrial cellular base station. The processing system may next identify, based upon the at least one communication, that a first communication coverage zone of the terrestrial cellular base station is within a second communication coverage zone of the communication satellite. In addition, the processing system may determine, in response to identifying that the first communication coverage zone of the terrestrial cellular base station is within the second communication coverage zone of the communication satellite, a potential interference between the communication satellite and the terrestrial cellular base station. The processing system may then apply a transmission beam coverage hole co-located with the first communication coverage zone of the terrestrial cellular base station, in response to the determining of the potential interference between the communication satellite and the terrestrial cellular base station.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for a processing system of a communication satellite applying a transmission beam coverage hole co-located with a first communication coverage zone of a terrestrial cellular base station in response to determining a potential interference between the communication satellite and the terrestrial cellular base station; and

FIG. 3 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for a processing system of a communication satellite applying a transmission beam coverage hole co-located with a first communication coverage zone of a terrestrial cellular base station in response to determining a potential interference between the communication satellite and the terrestrial cellular base station. In particular, examples of the present disclosure provide for interference mitigation related to non-terrestrial network (NTN)-based access to a cellular network. For instance, one or more NTN nodes (e.g., communication satellites) may provide direct cellular network access for cellular endpoint devices. Notably, satellite access has become an essential component of user connectivity, especially in remote areas. For instance, a non-terrestrial network (NTN) (e.g., a satellite access network (SAN)) can extend cellular coverage to areas where a terrestrial cellular network is not available or not economically viable. In addition, during natural disasters, satellite connectivity may comprise an important backup option to provide connectivity where terrestrial cellular infrastructure has been damaged. With even more satellite launches to meet increased demand, endpoint devices in some scenarios may be in an area covered by one or more communication satellites as well as one or more terrestrial base stations. In addition, some communication satellites may have non-geostationary orbits. These satellites may therefore provide time-varying coverage over various areas associated with the respective satellite orbits, which may overlap with various terrestrial base station coverage zones, e.g., cell footprints.

In this regard, examples of the present disclosure may optimize the use of both terrestrial cellular infrastructure and NTN nodes/communication satellites while minimizing interference and improving connection quality. In addition, examples of the present disclosure may maximize the coverage through interworking between satellite and terrestrial cellular services to provide cellular network connectivity to endpoint devices in coverage gaps of terrestrial cells. For instance, examples of the present disclosure may avoid (or at least reduce) the interference between satellite/NTN node-based and terrestrial cell-based connections in spectrum reuse scenarios. In addition, in one example, the present disclosure may set different power thresholds for different beams and/or beam directions to optimize the satellite connection performance.

Notably, a communication satellite (e.g., a cellular communication-capable satellite) can service many endpoint devices which are spatially distributed across a satellite coverage zone. However, the communication satellite may provide one or more beams that may vary in time, frequency, and/or spatial characteristics. While communication satellites may provide basic cellular connectivity for endpoint devices in remote locations, such satellite connections may result in higher latency compared to terrestrial cellular network connections. This may negatively impact the performance of various applications. In addition, there may be higher costs associated with using satellite connections depending on the pricing models of satellite service providers.

When a communication satellite uses the same spectrum as that of a terrestrial cellular network, the potential for interference arises. Examples of the present disclosure thus address the ability for spectrum sharing without causing interference between NTN node-based connections and terrestrial cell-based connections. To further illustrate, in one example, a communication satellite (e.g., a NTN node equipped/configured for direct cellular communication) may monitor terrestrial cellular coverage. For instance, the communication satellite may monitor the strength and availability of terrestrial cellular connections, from which the communication satellite may determine whether the establishment of a satellite connection is warranted. In one example, a terrestrial base station may have direct communication connections to one or more communication satellites to report its present status (e.g., its actual coverage/footprint/directivity, on/off status, load (e.g., a number of connected devices, a data volume, etc.), and so forth) and/or to report an anticipated status at a future time (such as a beam pattern cycle/schedule, an active/standby schedule, etc.). Alternatively, or in addition, in one example, an endpoint device may report to a communication satellite when the endpoint device senses terrestrial cellular coverage (and/or when no terrestrial cellular coverage is detected), and may provide additional information, such as the endpoint device location, a signal strength, a signal to noise ratio, a frequency band, channel information, an identity of the base station and/or sector, a base station location, and so forth.

In one example, a communication satellite may utilize the foregoing information to predict terrestrial cellular connection availability and to identify areas/regions of potential interference between terrestrial and satellite-based cellular communications, particularly where the communication satellite may reuse a terrestrial cellular network's licensed spectrum. For instance, the prediction of potential interference may be based on signal strength (e.g., for either or both of terrestrial and satellite-based cellular connections), endpoint device and/or terrestrial base station location, satellite geostationary position, orbit, and/or ground track, etc. In one example, satellite coverage may be dynamically divided into sub-directions, each with independent transmit power control. In one example, when there are no terrestrial base stations present, a communication satellite may apply a wide beam. However, with terrestrial cell sites/base stations present, a communication satellite may split coverage into smaller beams in different sub-directions. For instance, the directional beam split may be accomplished by adjusting the antennas on the satellite to focus coverage (e.g., a transmit beam and/or a transmit/receive beam) on specific areas while avoiding overlaying with the terrestrial cellular network's coverage. In addition, the communication satellite may control per direction time averaged power. For instance, transmitted power towards specific areas may be reduced by backing off the power or turning off when terrestrial cellular sites are detected. In this regard, a communication satellite may continuously monitor the connection status for satellite-connected endpoint devices and adjust satellite beam direction and/or satellite beam splitting/merging to optimize connection quality.

Likewise, the communication satellite may set transmit power levels for different directions based on traffic demand. For instance, the communication satellite may dynamically enhance the transmit power in certain direction(s) in response to real time user traffic. In one example, control messaging, such as system information block (SIB) messaging from a communication satellite to an endpoint device may cause the endpoint device to initiate scanning of cellular bands supported by a terrestrial base station if a terrestrial cellular connection is predicted to be available within a certain time frame that would render a satellite connection unnecessary. The endpoint device may report to the communication satellite, which may instruct the endpoint device to prepare for satellite disconnection by initiating a connection to the terrestrial cellular base station. In one example, the communication satellite may also reduce or cease transmit power as the coverage zone/footprint of the terrestrial cell and the satellite beam intersect. In one example, when no endpoint device is detected within a beam, a communication satellite can also reduce or eliminate a power level on a specific beam for energy saving (which may also reduce interference due to reflection, etc. with respect to nearby terrestrial cells).

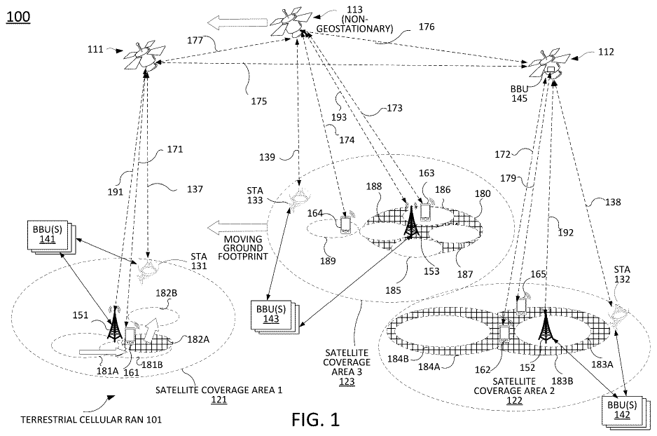

Thus, examples of the present disclosure enable an adaptive spectrum reuse to dynamically provide cellular-over-satellite connections for endpoint devices in small or large coverage gaps of a terrestrial cellular network. In particular, a communication satellite may refine the satellite beams to avoid interference with terrestrial cellular connections. Similarly, a communication satellite may merge/split beams to provide coverage to a wider area without cellular coverage (such as national park) or to optimize coverage in a smaller area with terrestrial coverage gaps/blind spots (such as a portion of an interstate highway, a small town center, etc.) using adjustable transmit power factors on directional beams. Accordingly, examples of the present disclosure may contribute to a robust and scalable cellular network (or cellular/NTN hybrid network) capable of meeting evolving communication demands. It should also be noted that the term “non-terrestrial network” (NTN) represents a plethora of connection scenarios, including satellite-based communications via airborne stations, air-to-ground or uncrewed aerial vehicles (UAV) flight control, and so forth. Thus, examples of the present disclosure are not limited to satellite communications but may also be expanded to air to ground or UAVs, balloons, etc. These and other aspects of the present disclosure are discussed in greater detail below in connection with the examples of FIGS. 1-3.

FIG. 1 illustrates an example network, or system 100 in which examples of the present disclosure may operate. In one example, the system 100 includes a terrestrial cellular radio access network (RAN) 101 (e.g., a 5G RAN, a 5G/4G/Long Term Evolution (LTE) hybrid RAN, an evolved Universal Terrestrial Radio Access Network (eUTRAN), or the like). In one example, the terrestrial cellular radio access network (RAN) 101 may comprise a cloud RAN. For instance, a cloud RAN is part of the 3^{rd} Generation Partnership Project (3GPP) 5G specifications for mobile networks. As part of the progression of mobile/cellular networks towards 5G, a cloud RAN may be coupled to a 5G core network and/or to an Evolved Packet Core (EPC) network until new cellular core networks are deployed in accordance with 5G specifications.

To further illustrate, the terrestrial cellular RAN 101 may include a plurality of cell sites 151-153, which may each comprise a radio unit (RU) or remote radio head (RRH) of a cellular base station, e.g., a gNodeB, or gNB. In addition, the terrestrial cellular RAN 101 may include a plurality of baseband units (BBUs) 141-143, which may be associated with one or more cellular base stations (e.g., gNBs). For instance, the BBUs 141-143 may represent one or more distributed units (DUs) and/or one or more centralized units (CUs) assigned to one or more cellular base stations and/or cell sites. It should be noted that in accordance with an Open-Radio Access Network (ORAN) architecture, CUs and DUs may be disaggregated and deployed on computing resources at different physical locations. However, for ease of illustration, these components are represented collectively as BBUs (e.g., BBUs 141-143, illustrated as BBU pools).

In particular, a BBU pool may be located at distances as far as 20-80 kilometers or more away from the antennas/remote radio heads of cell sites that are serviced by the BBU pool. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less. Although cloud RAN infrastructure may include distributed RRHs and centralized baseband units, a heterogeneous network may include cell sites where RRH and BBU components remain co-located at the cell site. For instance, a cell site may include RRH and BBU components and may thus comprise a self-contained “base station.”

FIG. 1 also illustrates various endpoint devices 161-165, e.g., user equipment (UEs) such as cellular endpoint devices. For instance, endpoint devices 161-165 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing devices (broadly, “an endpoint device”). In one example, endpoint devices 161-165 may each be equipped with one or more directional antennas, or antenna arrays (e.g., having a half-power azimuthal beamwidth of 120 degrees or less, 90 degrees or less, 60 degrees or less, etc.), e.g., multiple input-multiple output (MIMO) antenna(s) to receive multi-path and/or spatial diversity signals. Some or all of the endpoint devices 161-165 may also include a gyroscope and compass to determine orientation(s), a global positioning system (GPS) receiver for determining a location (e.g., in latitude and longitude, or the like), and so forth. In one example, some or all of the endpoint devices 161-165 may include a built-in/embedded barometer from which measurements may be taken and from which an altitude or elevation of the respective endpoint device may be determined. In one example, some or all of the endpoint devices 161-165 may also be configured to determine location/position from near field communication (NFC) technologies, such as Wi-Fi direct and/or other Institute of Electrical and Electronics Engineers (IEEE) 802.11 communications or sensing (e.g., in relation to beacons or reference points in an environment), IEEE 802.15 based communications or sensing (e.g., “Bluetooth™,” “ZigBee™,” etc.), and so forth.

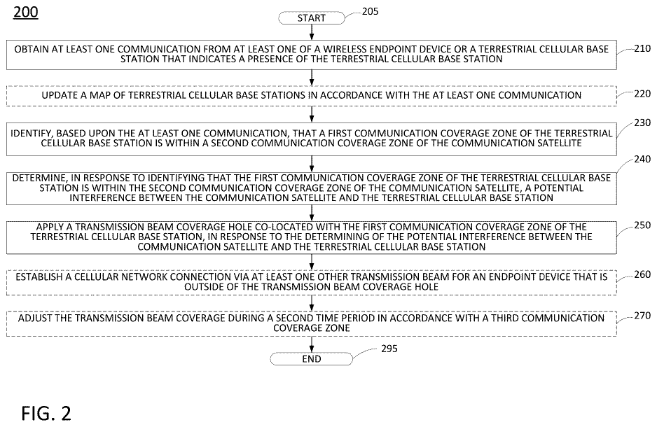

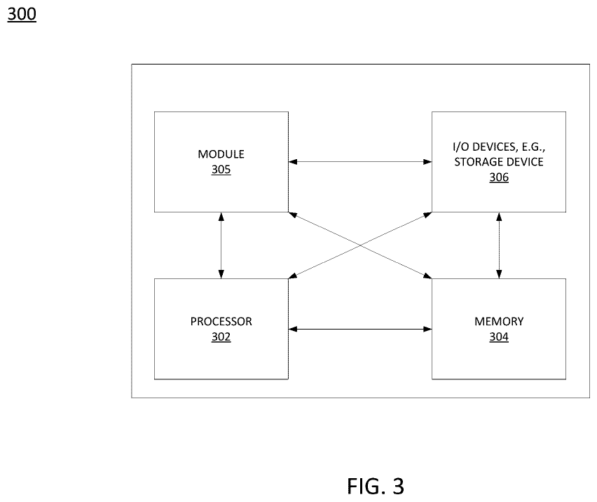

In one example, each of endpoint devices 161-165 may comprise all or a portion of a computing system, such as computing system 300 depicted in FIG. 3, and may be configured to perform one or more steps, functions, and/or operations in connection with examples of the present disclosure, such as illustrated and described in connection with the example method 200 of FIG. 2. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

As further illustrated in FIG. 1, the system 100 includes satellites 111-113 (e.g., communication satellites, which may also be referred to herein as non-terrestrial network (NTN) nodes)), each having a respective satellite coverage areas 1-3 (121-123). The satellites 111-113 together with ground stations (STA) 131-133 may comprise a non-terrestrial network (NTN), e.g., a satellite network. Notably, 3GPP standards (e.g., release 17 and beyond) expand the concept of cellular services over non-terrestrial networks in which satellites or other NTN nodes may include 3GPP new radio (NR) compliant technologies. For instance, in the example of FIG. 1, satellites 111-113 may each include remote radio heads (RRHs) and/or radio units (RUs), e.g., according to O-RAN definitions. In some examples, satellites or other NTN nodes may also include BBUs, DUs, and/or CUs. For instance, in FIG. 1, satellite 112 may include a BBU 145.

In one example, each of the satellites 111-113 may comprise all or a portion of a computing system, such as computing system 300 depicted in FIG. 3, and may be configured to perform one or more steps, functions, and/or operations in connection with examples of the present disclosure for a processing system of a communication satellite applying a transmission beam coverage hole co-located with a first communication coverage zone of a terrestrial cellular base station in response to determining a potential interference between the communication satellite and the terrestrial cellular base station, such as illustrated and described in connection with the example method 200 of FIG. 2. In various examples, one or more NTN nodes/satellites may dynamically map to one or more baseband units. For instance, satellite 111 may establish feeder links with either of ground stations 131 or 133, via which satellite 111 (e.g., a radio unit/RRH thereof) may be associated with one of the BBUs 141 or 143. However, for illustrative purposes, only a connection between satellite 111 and STA 131 is shown in FIG. 1 (which may associate satellite 111 with BBU(s) 141). In addition, in another example, satellite 111 may maintain an inter-satellite link (ISL) 175 with satellite 112 by which it may be associated with BBU 145. Thus, RRHs deployed to NTN nodes (e.g., satellites 111-113) may be paired with different BBUs to complete respective disaggregated base stations over a hybrid cellular/NTN network (and similarly for satellite 112 and/or satellite 113).

Each of the satellites 111-113 may have one or more feeder links 137-139) to one or more ground stations (e.g., also referred to as satellite gateways or satellite access nodes), e.g., ground stations (STAs) 131-133. In addition, the satellites 111-113 may have inter-satellite links (ISLs) 175-177 as further illustrated in FIG. 1. In accordance with the present disclosure, satellites 111-113 may each provide cellular network connectivity services to endpoint devices in connection with terrestrial cellular RAN 101. For instance, satellite 111 may serve endpoint device 161 via beam 182A. The connection for endpoint device 161 to satellite 111 may be referred to as a “service link” (e.g., service link 171). Notably, satellite 111 may be capable of providing beam coverage anywhere within satellite coverage area 1 (121). However, to support performance (e.g., data rates, throughput, latency, etc.) that is the same or as close as possible to terrestrial cellular service, more focused directional beams may customarily be used (e.g., such as illustrated by beam 182A). It should be noted that in one example, satellite 111 may adjust one or more beams, e.g., using one or more beamforming techniques. For instance, the beam 182A may be shifted to provide beam 182B, which may have a ground footprint different than that of beam 182A. For ease of illustration, only a single beam (e.g., where 182A and 182B may be the same beam, but at different times and with different beamforming configurations/settings) is shown for satellite coverage area 1 (121), where it should be understood that additional beams of a same or similar nature may be provided by satellite 111 in other portions of satellite coverage area 1 (121). Similarly, satellite 112 may offer various beams, such as beam 184A/184B within satellite coverage area 2 (122). For example, endpoint device 162 may have a service link 172 with satellite 112 established over beam 184A. In addition, endpoint device 165 may have a service link 179 with satellite 112 over a different beam (not shown).

Likewise, satellite 113 may also provide beams 185-189. In particular, satellite 113 may comprise a low earth orbit (LEO) satellite or a medium earth orbit (MEO) satellite, such as a non-geostationary satellite which may be at a lower altitude than satellites 111 and 112. For instance, satellites 111 and 112 may comprise high earth orbit (HEO), geostationary satellites. Accordingly, the satellite coverage area 1 (121) and satellite coverage area 2 (122) may be substantially larger than the satellite coverage area 3 (123). It should be understood that endpoint devices 161-165 or others may similarly obtain service links with any of the satellites 111-113 for which the respective endpoint devices are within an associated one of the satellite coverage areas 1-3 (121-123), and that the corresponding ones of the satellites 111-113 may provide directional beams to support the service links for one or a plurality of such endpoint devices. Similarly, any of the endpoint devices 161-165 may attach to terrestrial cellular network 101 via any of the cell sites 151-153 that is/are within communication range. In this regard, FIG. 1 illustrates coverage zone or footprint 181A/181B of cell site 151, footprint 183A/183B of cell site 152, and footprint 180 of cell site 153.

It should be noted that FIG. 1 illustrates two architecture modes for extending cellular services across NTN air interfaces to endpoint devices. In particular, in a non-regenerative mode, also referred to as a transparent mode, the uplink may involve a satellite radio unit (RU) or RRH receiving uplink data traffic from endpoint devices via service links, and forwarding the data traffic to a ground station via a feeder link, where the ground station may further pass the data traffic to a baseband unit. For instance, in one example, satellite 111 may receive data traffic from endpoint device 161 via service link 171, and may retransmit the data traffic via feeder link 137 to ground station 131. In turn, ground station 131 may pass the data traffic to one of the BBUs 141. The uplink may follow a similar pattern in reverse. For example, uplink data for endpoint device 161 may be received at one of the BBUs 141, e.g., from a cellular core network element (such as a user plane function (UPF), etc.) and may be forwarded to ground station 131 for transmission to satellite 111 via feeder link 137. The satellite 111 may retransmit the data traffic via service link 171 over beam 182A to endpoint device 162.

In a regenerative model, the entire RAN infrastructure (or at least an RU and DU) may be deployed to a NTN node. For instance, FIG. 1 illustrates that satellite 112 may include a baseband unit 145 (e.g., in addition to an RU/RRH (not shown)). In this case, BBU 145 may establish links/interfaces to cellular core network components (e.g., a UPF, an access management function (AMF), etc.) via ground station 132. For instance, while the data flow for serving endpoint device 162 may be similar to the transparent mode, the demarcation points for different RAN and cellular core links/interfaces are different. To further illustrate, satellite 112 may receive uplink data traffic from endpoint device 162 via service link 172. BBU 145 may process the data traffic and may retransmit the data traffic via feeder link 138 to ground station 132. In turn, ground station 132 may pass the data traffic to a cellular core network element/network function (e.g., a UPF, or for management traffic an AMF, etc.). Similarly, ground station 132 may receive uplink data traffic, e.g., from a cellular core network element, and may transmit the data traffic to satellite 112 (e.g., to BBU 145). BBU 145 may process the data traffic and may retransmit the data traffic to endpoint device 162 via service link 172.

It should be noted that BBU 145 may process data traffic not only for endpoint device 162 and/or others having service links to satellite 112, but also for other endpoint devices having service links via other satellites. For instance, in one example, satellite 111 may provide cellular network access to endpoint device 161, e.g., via service link 171. However, satellite 111 may associate itself with BBU 145 rather than a terrestrial-based BBU. In this case, uplink data traffic for endpoint device 161 may be received via service link 171 and retransmitted via inter-satellite link (ISL) 175 to BBU 145. BBU 145 may process the data traffic and in one example may retransmit the data traffic via feeder link 138 to ground station 132 (e.g., for onward forwarding to a cellular core network). Uplink data traffic for the endpoint device(s) 161 may follow a similar path in reverse. The use of regenerative mode and NTN-based BBUs may enable some satellites to continue to provide usable service links to endpoint devices even when a ground station is not visible or within communication range of such satellite, e.g., if the satellite is still able to maintain an ISL with another satellite. In addition, an NTN-based BBU, such as BBU 145, may also enable routing of data traffic between certain endpoint devices without the need to enter or traverse the cellular core network. This can be particularly advantageous where the routing of data traffic over feeder links can be avoided, e.g., resulting in substantial latency savings, etc. For instance, if endpoint device 162 is communicating with endpoint device 165 (e.g., having its own service link 179 to satellite 112 (not shown)), BBU 145 may hairpin the communication through satellite 112 without relay to ground station 132. It should be noted that this type of situation may occur frequently where users may be travelling in a group in the wilderness or traveling on a ship where satellite connectivity may be the only option or the most viable option to maintain connectivity to a cellular network, and where the users may often use their endpoint devices to maintain in voice and text contact when out of direct face-to-face communication range (such as at opposite ends of a ship, when a mile or more apart on a trail, etc.).

As noted above, examples of the present disclosure provide for continuous or nearly continuous cellular network connectivity via a NTN network for wireless access. However, satellite communication was not originally designed for high-speed/high-bandwidth connections for cellular endpoint devices. In addition, satellite communication is generally only used when there is no cellular coverage at all. In one example, higher satellites, such as those in HEO and/or geostationary orbits, may use lower band beams and provide wider coverage, while satellites with lower orbits, such as MEO or LEO satellites, may be capable of maintaining data connections at higher frequency bands and/or with wider channel bandwidths, but with reduced coverage. In one example, higher satellites may provide service links for control signaling and lower satellites may provide service links for higher data needs for temporary communications, e.g., to send and/or receive a text message, to make a short voice call, etc. For instance, in one example, an endpoint device may be paged for a voice call via a control channel over a service link with a first satellite/satellite beam and may then be provided with a secondary service link via a different satellite/satellite beam with a higher frequency and/or channel width to receive and send voice data.

As also noted above, examples of the present disclosure provide for satellites to apply transmission beam coverage holes co-located with communication coverage zone of terrestrial cellular base stations. For instance, an example method of a communication satellite applying a transmission beam coverage hole co-located with a first communication coverage zone of a terrestrial cellular base station in response to determining a potential interference between the communication satellite and the terrestrial cellular base station is illustrated in FIG. 2 and described in greater detail below. In this regard, FIG. 1 illustrates several examples of potential (or actual) interference between satellite coverages areas (e.g., beams thereof) and terrestrial communication coverage zones (e.g., cell footprints), as well as the potential responses to such potential (or actual) interference.

For instance, in a first example, cell site 151 may have a ground coverage area, or footprint 181A. In addition, satellite 111 may provide supplemental cellular network coverage/service via various beams within satellite coverage area 1 (121), e.g., while providing a null or coverage hole (e.g., no transmit beam) co-located with footprint 181. In this case, satellite 111 may provide one or more other beams that do not overlap with footprint 181A within the satellite coverage area 1 (121). For instance, a first beam 182A may have a ground coverage area as illustrated. For clarity and ease of illustration, one or more other beams of satellite 111 may be provided but are not specifically shown in FIG. 1. However, it should be understood that these may be of the same or similar nature as beam 182A, e.g., having a same half-power beam width, a same or similar transmit power, or range of transmit powers, operating in a same frequency band, etc.

Notably, a cell site, such as cell site 151, may have a varying coverage footprint that may result from beam steering, power saving mode activation, or the like. For instance, cell site 151 may shift/beam steer a beam (e.g., a transmit beam) such that footprint 181A shifts to a position illustrated as 181B. This may be as a result or in response to any number of reasons or factors, such as a schedule that varies the boresight direction for different times of the day, days of the week, months and/or seasons of the year, etc., an occurrence of an event, such as a sporting event, a concert, or similar temporary mass gathering, and so forth. However, this may result in the beam 182A overlapping with the terrestrial cell coverage/footprint 181B, and which may further cause interference with communications between cell site 151 and endpoint devices. For instance, beam 182A may transmit in the same band and/or uses the same frequencies as cell site 151, or may use frequencies that may otherwise result in interference in the band/frequencies in use at cell site 151.

In accordance with the present disclosure, satellite 111 may monitor the status of cell sites (e.g., cell site 151) that may fall within the ground coverage area 1 (121) to anticipate and/or to detect interference or potential interference, and to adjust one or more beams (e.g., transmit beams) of the satellite 111 in response. In one example, the satellite 111 may maintain direct communication with cell site 151. For instance, cell site 151 may be equipped with a transceiver and/or other equipment to function as a cellular endpoint device, and may communicate with satellite 111 via satellite direct-to-cellular communications, illustrated as direct link 191 in FIG. 1. For example, from the perspective of the satellite 111, the satellite 111 may communicate with cell site 151 as if cell site 151 were another cellular endpoint device obtaining cellular service via satellite 111. In one example, to avoid interference for this signaling/management communication itself, satellite 111 may provide a beam in a receive-only mode (e.g., a receive beam) for cell site 151 to transmit information about its current configuration and/or performance metrics to satellite 111. Alternatively, or in addition, satellite 111 may initially transmit and receive via a beam that covers cell site 151 (e.g., possibly overlapping with footprint 181A). However, satellite 111 may obtain information from cell site 151 via direct link 191 that indicates that it is causing interference with endpoint device communications with cell site 151. In response, satellite 111 may direct a null toward cell site 151 and/or a footprint thereof (e.g., footprint 181A). In one example, satellite 111 may periodically and/or intermittently activate a transmit beam to allow cell site 151 to upload configuration and/or performance metrics to satellite 111 and may then deactivate the beam to cause only minimal, temporary interference.

As noted above, in one example, cell site 151 may have a schedule according to which the coverage/footprint may vary from 181A to 181B. In addition, satellite 111 may be informed of this schedule, e.g., either via direct link 191 by cell site 151 itself and/or from other communications from terrestrial cellular RAN 101. However, it is possible that the schedule may change without notification to satellite 111. Alternatively, or in addition, cell site 151 may operate outside of the schedule due to any number of reasons, or a schedule provided to satellite 111 may be incorrect. In accordance with the present disclosure, satellite 111 may therefore continue to monitor the configuration and status of cell site 151. This may be accomplished via ongoing communication via direct link 191 and/or via monitoring and reporting by endpoint devices directly to satellite 111. For instance, according to a schedule, satellite 111 may expect that cell site 151 may be operating with coverage/footprint 181A. However, endpoint device 161 may monitor the wireless environment and may detect broadcast control signaling from cell site 151 indicating that the coverage/footprint is actually as illustrated by 181B. Endpoint device 161 may report this determination, or measurements indicative of the footprint 182B (such as a received signal strength indicator (RSSI) or the like) to satellite 111 via service link 171. To further illustrate, endpoint device 161 may obtain cellular network connectivity/service via service link 171 with satellite 111. At the same time, endpoint device 161 may be configured to monitor and report for terrestrial cell coverage. Thus, endpoint device 161 may detect at one time that there is no terrestrial cellular coverage when endpoint device 161 is located within the coverage of beam 182A of satellite 111. However, at a later time (e.g., at the same position), endpoint device 161 may detect cell site 151, such as detecting a system information block (SIB) broadcast, or the like. For example, cell site 151 may shift coverage from footprint 181A to 181B. In this case, endpoint device 161 may have overlapping coverage from cell site 151 and satellite 111. However, this may cause interference for endpoint device 161 and/or for other endpoint devices in positions of overlap between 181B and 182A.

In such an example, satellite 111 may determine that a null, or a hole in satellite coverage should be directed over 182A. In one example, satellite 111 may apply one or more beam steering techniques to change the beam coverage from 182A to 182B. In one example, this may provide a satellite coverage hole over 181B. In one example, prior to the change, satellite 111 may notify/instruct endpoint device 161 to prepare for disconnection of service link 171. In particular, since endpoint device 161 is now within footprint 181B, endpoint device 161 may obtain cellular network connectivity/service via cell site 151. As such, endpoint device 161 may initiate handover/attach procedures to attach to cell site 151.

It should be noted that in accordance with the present disclosure, a null, or coverage hole does not necessarily require that there be surrounding satellite coverage, e.g., via other beams of the same or different satellite. Thus, for example, there is no requirement that the beam 182A be adjacent to or surrounded by other beams of satellite 111 (however, in some instance, this may be the case). Similarly, in one example, satellite 111 may be capable of “filling in” where cell site 151 has left a gap in terrestrial cellular network coverage. For instance, satellite 111 may steer a different beam or may activate a previously inactive beam to provide satellite coverage where cell site 151 previously provided coverage at footprint 181A. Additional aspects of the same or a similar nature are further described in connection with the following examples.

To further illustrate, in a second example, cell site 152 may have a ground coverage area, or footprint 183A. Satellite 112 may therefore provide supplemental cellular network coverage/service via various beams within satellite coverage area 2 (122), e.g., while providing a null or coverage hole (e.g., no transmit beam) co-located with footprint 183A. In this case, satellite 112 may provide one or more other beams that do not overlap with footprint 183A within the satellite coverage area 2 (122). For instance, a first beam 184A may have a ground coverage area as illustrated. For clarity and ease of illustration, one or more other beams of satellite 112 may be omitted. However, it should be understood that these may be of the same or similar nature as beam 184A, e.g., a same or similar transmit power, or range of transmit powers, operating in a same frequency band, etc.

Notably, a cell site, such as cell site 152, may have a varying coverage footprint that may result from beam steering, power saving mode activation, or the like. For instance, cell site 152 may shift/beam steer a beam (e.g., a transmit beam) such that footprint 183A expands to cover a larger area illustrated as footprint 183B. This may be as a result of, or in response to any number of reasons or factors, such as a schedule that varies the boresight direction for different times of the day, days of the week, months and/or seasons of the year, etc., an occurrence of an event, such as a sporting event, a concert, or similar temporary mass gathering, and so forth. However, this may result in the beam 184A overlapping with the terrestrial cell coverage/footprint 183B and which may further cause interference with communications between cell site 152 and endpoint devices.

In accordance with the present disclosure, satellite 112 may monitor the status of cell sites (e.g., cell site 152) that may fall within the ground coverage area 2 (122) to anticipate and/or to detect interference or potential interference, and to adjust one or more beams (e.g., transmit beams) of the satellite 112 in response. In one example, the satellite 112 may maintain direct communication with cell site 152. For instance, cell site 152 may be equipped with a transceiver and/or other equipment to function as a cellular endpoint device, and may communicate with satellite 112 via satellite direct to cellular communications, illustrated as direct link 192 in FIG. 1. In one example, to avoid interference for this signaling/management communication itself, satellite 112 may provide a beam in a receive-only mode (e.g., a receive beam) for cell site 152 to transmit information about its current configuration and/or performance metrics to satellite 112. Alternatively, or in addition, satellite 112 may transmit and receive via a beam that covers cell site 152 (e.g., possibly overlapping with footprint 183A). However, satellite 112 may obtain information from cell site 152 via direct link 192 that indicates that it is causing interference with endpoint device communications with cell site 152. In response, satellite 112 may direct a null toward cell site 152 and/or a footprint thereof (e.g., footprint 183A). In other words, satellite 112 may avoid causing a transmit beam to fall within the footprint 183A, such as by disabling one or more transmit beams and/or reducing power of one or more transmit beams that may overlap with footprint 183A, by beam steering such that boresight directions of one or more beams cause the beams to avoid the footprint 183A, and so forth. To further illustrate, satellite 112 may provide a first beam 184A, which borders but does not intersect with footprint 183A.

In an illustrative example, cell site 152 may expand the footprint 183A to footprint 183B due to any one or more reasons, such as according to a schedule, due to a decrease in demand closer to cell site 152 and/or an increase in demand beyond the footprint 183A, etc. In an example in which cell site 152 may follow a schedule for changing from footprint 183A to 183B, satellite 112 may have advance knowledge of such schedule and/or advance knowledge of an instance of changing from footprint 183A to 183B. For instance, cell site 152 may report via direct link 192, if available. Alternatively, or in addition, terrestrial cellular RAN 101 may communicate a schedule (e.g., and the details of coverage, such as the bounds of footprints 183A and 183B, the timing of changes, the transmit power, the frequencies in use, etc.) to satellite 112, e.g., via STA 132, via STA 131 and satellite 111, etc.

Regardless of whether cell site 152 may follow a schedule, in accordance with the present disclosure satellite 112 may continue to collect information to verify current configurations of cell sites, such as cell site 152. Thus, for example, satellite 112 may continue to obtain updates from cell site 152 via direct link 192, e.g., on the initiative of cell site 152 that is about to make changes and/or by cell site 152 in response to a query from satellite 112 via direct link 192. Alternatively, or in addition, satellite 112 may collect network performance measurements and/or reports, e.g., with data points specific to determining interference, coverage overlap, etc. from endpoint devices within satellite coverage area 2 (122) and having service links with satellite 112. For instance, this may include endpoint devices 162 and 165 having service links 172 and 179, respectively. Notably, in some cases, satellite 112 may be unable to obtain timely updates from cell site 152 directly. For instance, in some cases, satellite 112 may be directing a null over cell site 152 (e.g., having footprint 183A) and cannot query the cell site 152 via direct link 192.

Continuing with the present example, endpoint device 162 may report to satellite 112 via service link 172 that endpoint device 162 does not detect cell site 152. In this case, satellite 112 may determine that cell site 152 is configured to provide footprint 183A (e.g., as opposed to footprint 183B). In another example, satellite 112 may be unaware of the specific bounds of footprint 183A from the reporting of a single endpoint device. However, in one example, satellite 112 may collect data on the wireless environment from multiple endpoint devices, such as endpoint devices 162 and 165 via service links 172 and 179, respectively. In this case, satellite 112 may estimate the bounds of footprint 183A based upon locations of endpoint devices that report detecting cell site 152 and/or that report being in a location within service ranges of cell site 152 (and/or based upon locations of endpoint devices that do not detect cell site 152 and/or which are outside of range to attach to cell site 152).

As noted above, at a later time, cell site 152 may expand coverage to provide a footprint 183B. For instance, cell site 152 may change the tilt of one or more antennas and/or may increase a transmit power, etc. In one example, cell site 152 may notify satellite 112 via direct link 192. However, in another example, direct link 192 may be unavailable. Nevertheless, endpoint device 162 and/or endpoint device 165 may report via service link 172 and/or service link 179 that the endpoint device(s) detect cell site 152 and/or are within range to attach to cell site 152. Accordingly, satellite 112 may determine that cell site 152 is operating with footprint 183B (or at least may determine that cell site 152 is operating with a footprint that intersects with beam 184A) with potential interference for endpoint device 162, endpoint device 165, and/or for other endpoint devices in positions of overlap between 183B and 184A.

In such an example, satellite 112 may determine that a null, or hole in satellite coverage should be directed over 184A. In one example, satellite 112 may apply one or more beam steering techniques to change the beam coverage from 184A to 184B. In one example, this may provide a satellite coverage hole over 183B. In one example, prior to the change, satellite 112 may notify/instruct endpoint device 162 and/or endpoint device 165 to prepare for disconnection of service link 172. In particular, since endpoint device 162 and endpoint device 165 are both now within footprint 183B, these endpoint devices may obtain cellular network connectivity/service via cell site 152. As such, endpoint devices 162 and 165 may initiate handover/attach procedures to attach to cell site 152.

It should be noted that in other, further, and different examples, the satellite 112 may apply other types of changes to a set of beams and/or characteristics of one or more beams applied within satellite coverage area 2 (122) in response to the changes to the footprint of cell site 152 from 183A to 183B. For instance, satellite 112 may deactivate at least beam 184A (e.g., without adjusting to beam 184B). In another example, satellite 112 may change a boresight direction of beam 184A, e.g., to shift the beam 184A to avoid the expanded footprint 183B of cell site 152. Thus, these and other modifications are all contemplated within the scope of the present disclosure.

In a third example, satellite 113 may be in motion relative to a fixed position on the ground, e.g., cell site 153. While cell site 153 may have a varying footprint, for illustrative purposes it may be assumed that cell site 153 operates with a relatively fixed footprint 180. In this case, satellite 113 may provide a number of beams within satellite coverage area 3 (123), only some of which are specifically illustrated (e.g., beams 185-189). The satellite 113, as well as the beams 185-189 and satellite coverage area 3 (123) as a whole, may be in motion in the direction indicated by the arrows. Thus, the beams 185-189 may move across the area of footprint 180. In this regard, satellite 113 may be configured to consider any overlap between a beam and a cell site footprint as having a potential for interference. As such, in one example, satellite 113 may activate and deactivate beams as the respective beams may intersect with footprint 180 of cell site 153. For example, FIG. 1 may illustrate a particular instance in time when beams 185-188 may intersect with footprint 180. As such, satellite 113 may disable and/or reduce transmit power for these beams during such time. In other words, satellite 113 may direct a null or coverage hole for satellite transmit beams over the footprint 180.

In one example, beam 189 may have been disabled at a prior time, but may have just moved out of an area of overlap with footprint 180. Accordingly, beam 189 may be recently reactivated at an instance in time as illustrated in FIG. 1. In one example, endpoint device 164 may report to satellite 113 via service link 174 that endpoint device 164 does not detect cell site 153 and/or is located such that endpoint device 164 is unable to attach to cell site 153 (e.g., being too far away and/or otherwise unable to maintain two-way communication). For instance, endpoint device 164 may report an indicator of whether cell site 153 is detectable or not, an RSSI associated with cell site 153, or the like. In one example, satellite 113 may utilize such information to determine that beam 189 should be activated and will not cause interference with communications of base station 153. Likewise, endpoint device 163 may report via service link 173 that it detects cell site 153 and/or is attached to cell site 153. Thus, satellite 113 may learn that endpoint device 163 is within footprint 180. For instance, while satellite 113 may not know the precise bounds of footprint 180, it may be aware that it at least includes the location of endpoint device 163 but does not include a location of endpoint device 164. It should be noted that insofar as satellite 113 may be non-geostationary, and insofar as satellite coverage area 3 (123) may be in motion, endpoint device 164 may have previously been served by satellite 113 via service link 174 over a different beam that may have since moved past the location of endpoint device 164. Thus, satellite 113 may continue to serve endpoint devices via different beams for as long as the endpoint devices are within the satellite coverage area 3 (123).

Similar to previous examples described above, in other, further, and different examples, satellite 113 may alternatively or additionally apply one or more other techniques to direct a null or coverage hole for satellite transmit beams over the footprint 180. For instance, satellite 113 may apply one or more beam steering techniques such as changing boresight directions such that beams 185-188 may fall outside the footprint 180. In addition, satellite 113 may adjust these boresight directions on an ongoing basis as the satellite 113/satellite coverage area 3 (123) moves over the cell site 153/footprint 180. It should also be noted that in one example, cell site 153 may report via direct link 193 its current configuration and/or status, e.g., including at least information defining footprint 180, such as geographic bounds, coordinates of cell site 153 plus a transmit power, half-power beamwidth for one or more sectors, etc. However, in one example, satellite 113 may additionally collect direct reports from endpoint devices 163, 164, etc. to verify the last received information from cell site 153. For example, satellite 113 may trust the last received information from cell site 153 but may adjust the null/coverage hole if more recent information from endpoint devices provide conflicting information on the footprint 180. Alternatively, or in addition, satellite 113 may learn that the cell site 153 appears to be disabled or deactivated. For instance, endpoint device 163 may report that is does not detect cell site 153. In such case, satellite 113 may activate at least beam 186 to provide connectivity for endpoint device 163 to terrestrial cellular RAN 101. For instance, satellite 113 may provide backup coverage for cell site 153 if and when cell site 153 may be disabled for any reason planned or unplanned (e.g., scheduled maintenance, upgrade, power outage, etc.).

As in the preceding examples, satellite 113 may cause potential temporary interference where beams may be active in areas of overlap with a cell site footprint. For instance, satellite 113 may activate beam 186 intermittently to enable reporting via service link 173 even where satellite 113 may have knowledge that beam 186 may overlap with footprint 180. However, such beam activations in areas of assumed overlap/interference may be used infrequently and only as long as necessary to obtain information on the wireless environment. Thus, satellite 113 may continue to obtain relatively updated information from endpoint devices and/or cell sites directly. More permanent service links for voice, data, and other user communications may be established outside any terrestrial coverage area, such as for endpoint device 164 via service link 174 over beam 189 outside of coverage area 180 of cell site 153.

In each of the foregoing cases, in one example, a respective satellite may apply one or more machine learning techniques to anticipate overlap and/or potential interference. For instance, geostationary satellites may have ground coverage areas that intersect with footprints of terrestrial cell sites that change over time. Similarly, for a non-geostationary satellite, the satellite's orbit may have a fixed or relatively fixed path such that the satellite coverage area over the ground follows a repeating pattern. However, the cell sites within such path may also change with time such that the satellite may forecast/predict terrestrial cell footprint and areas of potential interference where the satellite may direct a null/coverage hole for satellite transmit beams.

To further illustrate, in one example, a processing system of a satellite may implement a machine learning model (MLM) that is trained to generate/output a coverage hole/pattern and/or an active beam pattern that may result in a coverage hole over an area of potential interference with a terrestrial cell site. For instance, the MLM may be trained to output a selection of such a pattern in response to an input vector comprising one or more of: information from a cell site, information from one or more endpoint devices, and/or information from another source associated with a terrestrial cellular network, the information associated with a footprint/communication coverage zone of a terrestrial cellular base station. In particular, the MLM may be trained/configured to process an input or a set of inputs (e.g., an input vector) including base station location information, endpoint device location information, RSSI values and/or indicators of whether the base station is detected and/or within communication range of an endpoint device (or can maintain reliable two-way communication), etc. In one example, the input vector may also include information on the satellite capabilities and/or configuration (e.g., a number of antennas/or beams, frequency range of operation, a beam steering range for boresight and/or half power beam width, etc., a transmit power range, a satellite height over ground, and/or other factors). In one example, the input vector may include other factors, such as a time, a date, a day of the week, a month, etc.

In one example, such a MLM may be trained on historic data, but at any given time, an optimal beam pattern selection may be based on the input vector with the most recent/most up to date footprint and/or satellite configuration information. Accordingly, in one example, this may be incorporated into the input vector at runtime (e.g., as a satellite engages in beam pattern selection on an ongoing basis). However, in another example, insofar as satellites may have orbits that are fixed/predictable, factors such as time, date, and/or other temporal factors may also be embedded within the training of the MLM.

In one example, training data may comprise labeled records of beam pattern selections for a satellite, where the labels may indicate that interference with a terrestrial cell site did or did not occur. To illustrate, endpoint devices may report various performance metrics indicative of whether a level of service was acceptable or not, either over satellite service link or via a connection to a terrestrial base station. For instance, if a call drop rate, a call block rate, latency metrics, throughput metrics, or the like fail to meet one or more performance thresholds/benchmarks, the selected beam pattern may be labeled as unsuccessful (otherwise a label of “successful” may be applied), or may be labeled as “interference” (or “no interference”), etc.

Alternatively, or in addition, a user may provide feedback via an endpoint device of whether the service was acceptable or not acceptable (e.g., in terms of the ability to transmit and receive data and/or in terms of battery charge consumption, etc.). In still another example, the labels may be on a scale, such as 1-5, 1-10, 0-10, 0-100, etc. indicating a level or percentage of interference (or lack thereof). For instance, a formula may be based on one or more of the foregoing factors (e.g., call drop rate, call block rate, latency, throughput, etc.), where an output “score” or value may indicate the relative level of success. This label may then be used in conjunction with corresponding records data regarding the beam pattern selections as training data for MLM training. In one example, the training data may be specific to the satellite training and operating the MLM, such as one of the satellites 111-113 of FIG. 1.

It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, MLMs of the present disclosure may include an ML-based generative model, such as a language model, e.g., a “large language model” (LLM). For instance, a ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. In one example, the present disclosure may fine-tune a base language model or may custom-build a language model to provide high-level instructions for radio access network (RAN), cellular network, and/or satellite network-specific issues. In addition, in one example, the present disclosure may further enhance such a fine-tuned MLM to provide concrete, actionable instructions, e.g., satellite transmit beam coverage hole and/or beam pattern selections. For instance, a generative language model of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store, as well as current NTN node information (e.g., associated with satellite 111-113, the beams thereof, etc.), cell site, and/or endpoint device information such as described above. In one example, input data for such a LLM-based generative model may include converting categorical or numerical data to text form, as well as vectorization of textual data to vectors (e.g., via word2vec, doc2vec, Global Vectors for Word Embedding (GloVe), or the like, using n-grams, and so forth). In one example, tailored prompts may be used in connection with a generative MLM of the present disclosure, e.g., to obtain outputs that may comprise instructions in useable format with respect to other network functions, such as outputs formatted for 3GPP/5G standards compliant communications, IEEE 802.11 standards compliant communications, or the like. For instance, the prompt may explicitly request a selection of a beam pattern comprising one or more transmit beams of a satellite, e.g., where the prompt may list the available transmit beams and/or where further information about the wireless environment may be obtained from a cell site and/or from one or more endpoint devices for appending as RAG content. Additional functionality and operations of NTN nodes in accordance with the preset disclosure are discussed in connection with the example method 200 of FIG. 2.

It should be noted that FIG. 1 illustrates (and the foregoing describes) just several examples in accordance with the present disclosure. Thus, it should be appreciated that other, further, and different examples may readily be devised in accordance with the present disclosure. As just one example, the system 100 may alternatively or additionally include NTN nodes of varying types, such as balloons, UAVs, etc. In addition, it should be understood that the present disclosure is not limited to specific bands, bandwidth channels, satellite deployment types, cellular RAN fronthaul architectures, and so forth. In one example, endpoint devices may include selection logic to evaluate and select a best beam from among a plurality of available beams of one or more satellites to establish a service link, and to maintain satellite-based attachment to the terrestrial cellular RAN 101.

It should be noted that in some examples, the satellite network (e.g., satellites 111-113 and ground stations 131-133) may be controlled and/or operated by one or more entities that are different from the terrestrial cellular RAN and/or a cellular core network associated therewith. As such, in different examples, satellite access components (e.g., satellites 111-113 and ground stations 131-133) may be designated as trusted or untrusted, such that data ingress and egress to the cellular core network may be via shared gateway, a security gateway (SeGW), and/or a non-3GPP inter-working function (N3IWF) (e.g., a non-cellular network interworking function). In particular, a N3IWF enables protocol data unit (PDU) session establishment via a UPF for endpoint devices connecting to external networks beyond the cellular core via trusted and untrusted non-cellular (e.g., non-3GPP) access networks. These can include IEEE 802.11/Wi-Fi networks, and in accordance with the present disclosure, may further include satellite access networks. In this regard, it should also be noted that the terrestrial cellular RAN 101 may also interface with one or more cellular core networks, some or all of which may be operated by a different entity other than the terrestrial cellular RAN 101. For example, the terrestrial cellular RAN 101 may comprise a private cellular network or a RAN of a peer cellular network. For instance, in one example, terrestrial cellular RAN 101 may be made available by a host mobile network operator (MNO) that provides for shared use of terrestrial cellular RAN 101 by one or more other MNOs, e.g., those operating one or more cellular core networks.

In addition, the foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For instance, intermediate devices and links between cell sites 151-153 or BBUs 141-143 and other components of system 100 are omitted for clarity, such as additional routers, switches, gateways, and the like. Likewise, links to one or more cellular core networks are also omitted for ease of illustration. Thus, these and other modifications are all contemplated within the scope of the present disclosure.

FIG. 2 illustrates a flowchart of an example method 200 for a processing system of a communication satellite applying a transmission beam coverage hole co-located with a first communication coverage zone of a terrestrial cellular base station in response to determining a potential interference between the communication satellite and the terrestrial cellular base station, in accordance with the present disclosure. In one example, steps, functions and/or operations of the method 200 may be performed by an apparatus as illustrated in FIG. 1, e.g., satellites 111-113 (e.g., NTN nodes), and/or one of the satellites 111-113 in conjunction with one or more others of the satellites 111-113, one or more ground stations, cell sites, endpoint devices, and so forth. In one example, the steps, functions, or operations of method 200 may be performed by a computing device or system 300, and/or a processing system 302 as described in connection with FIG. 3 below. For instance, the computing device or system 300 may represent at least a portion of device or system deployed in a cellular network that is configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system, such as processing system 302. The method 200 begins in step 205 and proceeds to step 210.

At step 210, the processing system (e.g., of a communication satellite/NTN node) obtains at least one communication from at least one of: a wireless endpoint device or a terrestrial cellular base station that indicates a presence of the terrestrial cellular base station. In one example, the at least one communication indicates a first communication coverage zone of the terrestrial cellular base station for a first time period. In one example, the at least one communication may indicate the first communication coverage zone for the first time period and a third communication coverage zone of the terrestrial cellular base station for a second time period. For instance, the terrestrial cellular base station may have a schedule of beam pattern changes and/or may have a scheduled change that it may notify to the communication satellite in advance. In one example, the at least one communication may be a first communication that is obtained from the terrestrial cellular base station and that indicates the first communication coverage zone, where the at least one communication may further comprise a second communication from the wireless endpoint device. In one example, the terrestrial cellular base station is a new base station, e.g., a cell on wheels (CoW) or the like. For instance, in one example, the first communication can indicate an expected duration of the presence of the CoW.

In various examples, the at least one communication (e.g., the indication of the presence of a terrestrial cellular base station contained in the at least one communication) may include base station/cell site location information (e.g., coordinates, altitude, etc.), endpoint device location information (e.g., coordinates, altitude, etc.), cell site antenna orientation information, endpoint device/antenna orientation information, a RSSI, a signal to noise (SNR) ratio, a signal to interference and noise (SINR) ratio, a frequency and/or frequency band, a cell ID (e.g., identifying the terrestrial cellular base station), a round trip time (RTT) of one or more test packets/probes, or the like, a packet loss, a jitter measurement or other delay measure, a bandwidth measure, base station/cell site load information, and so forth. In one example, the at least one communication may include a set or sequence of one or more of such measures, e.g., RSSIs collected over a period of time as an endpoint device may be in same location or in different locations within an area (e.g., as a user may walk in an area over the course of 5 seconds, 30 seconds, a minute, etc.).

At optional step 220, the processing system may update a map of terrestrial cellular base stations in accordance with the at least one communication. For instance, the communication satellite may store the map, where the map may also be updated in accordance with a communication from a network operator of a cellular network including the terrestrial cellular base station. For example, the network operator may provide a map that may be updated each month, quarterly, etc. However, the communication satellite may make its own updates to a locally stored map based upon the most recent data collected from base stations and/or endpoint devices. The map may include coordinates and/or elevation information of one or more cell sites. In addition, the map may include or may reference another data set that stores additional information regarding one or more cell sites, such as the mast height, antenna/RRH height, sector information (e.g., sector orientations, configurations, etc.), antenna array types, bands supported, etc., time averaged transmit power, footprint information (e.g., a cell boundary, or cell boundaries for respective frequency bands, transmit power configurations, etc.), and other information, such as average numbers of endpoint devices served (e.g., a number of devices attached to the cellular network via the cell site), and so forth. In one example, the information may also include footprint pattern change schedules or the like for the one or more base stations.

At step 230, the processing system identifies based upon the at least one communication, that a first communication coverage zone of the terrestrial cellular base station is within a second communication coverage zone of the communication satellite. For instance, in one example, the identifying that the first communication coverage zone of the terrestrial cellular base station is within the second communication coverage zone of the communication satellite may be based on the map of terrestrial cellular base stations. In one example, the communication satellite may be in a non-geostationary orbit. In such case, the identifying that first communication coverage zone of the terrestrial cellular base station is within the second communication coverage zone of the communication satellite may be further based upon the non-geostationary orbit. For instance, in such an example, step 230 may include determining a ground path projection of one or more transmit beams of the communication satellite (such as satellite coverage area 3 (123) of FIG. 1) and determining that the ground path projection intersects with the first communication coverage zone (such as footprint 180 of base station 153 of FIG. 1), e.g., according to the stored map, or the like.

In one example, the first communication coverage zone of the terrestrial cellular base station may be associated with a first time period. In such an example, step 230 may include identifying that the first communication coverage zone of the terrestrial cellular base station is to be within the second communication coverage zone of the communication satellite in the first time period. For instance, as noted above, the first communication may indicate the first communication coverage zone for the first time period. Alternatively, or in addition, the communication satellite may learn a pattern for changes of the first communication zone, such as a schedule that changes the beam pattern on a daily basis, e.g., respective coverage zones for day and night, for weekdays and weekends, etc. For instance, the communication satellite may learn the patterns based on reporting from the terrestrial cellular base station and/or from endpoint devices within the coverage zone(s).

As noted above, in one example, the at least one communication obtained at step 210 may include: (a) a first communication that is obtained from the terrestrial cellular base station and that indicates the first communication coverage zone, and (b) a second communication from a wireless endpoint device. Accordingly, in one example, step 230 may include verifying the first communication coverage zone based on the at least the second communication. For instance, the verifying may include verifying the changing pattern as last indicated by the base station based upon the most recent reporting from a threshold number of endpoint devices.

At step 240, the processing system determines, in response to identifying that the first communication coverage zone of the terrestrial cellular base station is within the second communication coverage zone of the communication satellite, a potential interference between the communication satellite and the terrestrial cellular base station. For instance, the communication satellite and the terrestrial cellular base station may utilize a same spectrum, where the determining of the potential interference may include determining that the communication satellite and the terrestrial cellular base station utilize the same spectrum. However, in another example, the communication satellite and the terrestrial cellular base station may use different spectrum/spectrum bands, but may still have interference, e.g., due to harmonics, non-linear interactions, etc. In one example, the terrestrial cellular base station may have different coverage zones associated with respective frequencies/frequency bands, e.g., there may be more than one cell footprint of the terrestrial base station, e.g., smaller for higher frequencies/smaller wavelengths, longer for shorter frequencies/larger wavelengths. However, it should be noted that in one example, the communication satellite may be configured to avoid overlap with coverage zone(s) of a terrestrial cellular base station regardless of frequency or potential for interference. For instance, it may be still be beneficial to avoid the use of satellite-based direct-to-cellular services when terrestrial services are available, even if at lower frequencies with reduced data rates at cell/footprint edges.

At step 250, the processing system applies a transmission beam coverage hole co-located with the first communication coverage zone of the terrestrial cellular base station, in response to the determining of the potential interference between the communication satellite and the terrestrial cellular base station. It should be noted that as referred to herein, “co-located” does not necessarily mean precisely overlapping or inclusive. For example, “co-located” may describe as much overlap or inclusion as possible given the available satellite beams and/or the boresight adjustment range or other beamforming controls available with respect to the beams. In one example, the applying of the transmission beam coverage hole may include disabling at least one transmit beam of at least one antenna of the communication satellite. In one example, the applying of the transmission beam coverage hole may alternatively or additionally include adjusting a boresight direction of at least one transmit beam of at least one antenna of the communication satellite.

At optional step 260, the processing system may establish a cellular network connection via at least one other transmission beam for an endpoint device that is outside of the transmission beam coverage hole. For example, the endpoint device may communicate wirelessly with a RRH of the communication satellite via a service link over the at least one other transmission beam in the same or a similar manner as if the endpoint device was communicating with a terrestrial RRH, e.g., via a Uu interface. In one example, step 260 may further include establishing an N1 link to an AMF in a cellular core network, establishing a PDU session, e.g., via a UPF in the cellular core network, and so forth.

At optional step 270, the processing system may adjust the transmission beam coverage during a second time period in accordance with a third communication coverage zone. For instance, in one example, the third communication coverage zone may be larger than the first communication coverage zone, where the adjusting may include increasing a size of the transmission beam coverage hole in accordance with the third communication coverage zone, e.g., via beam steering techniques and/or disabling one or more additional transmit beams of the communication satellite, or the like. In another example, the third communication coverage zone may be smaller than the first communication coverage zone. In such an example, optional step 270 may include reducing a size of the transmission beam coverage hole in accordance with the third communication coverage zone. In one example, the third communication coverage zone may be a shifted version of the first communication coverage zone, in which case optional step 270 may include shifting the bounds, boresight direction, or other pattern aspect(s) of the transmission beam coverage hole, which may be accomplished via beam steering of at least one transmit beam, deactivating at least one transmit beam, and/or activating at least one other transmit beam, and so forth.

In one example, optional step 270 may also include or may be preceded by verifying the third communication coverage zone. For instance, the terrestrial base station may indicate via the communication of step 210 the base station's expected/normal beam changing pattern, e.g., for time of day, day of week, etc. However, this pattern could be altered or superseded where the communication satellite may be unaware of the change prior to its occurrence. As such, the endpoint devices may report actual observations during the second time period, which can confirm or contradict the pattern previously asserted by the terrestrial cellular base station.

Following step 250 or one of the optional steps 260-270, the method 200 proceeds to step 295 where the method 200 ends.

It should be noted that the method 200 may be expanded to include additional steps or may be modified to include additional operations with respect to the steps outlined above. For example, the method 200 may be repeated on an ongoing basis to perform steps 210-250, steps 250-260, steps 220-270, etc. In one example, the third communication coverage zone may instead be no coverage, e.g., the base station is deactivated, disabled, etc. In such case, optional step 270 may include filling in the coverage hole via beam steering and/or activating one or more transmit beams that may have previously been inactive. In one example, step 210 may allow signal strength reporting from endpoint devices, where the processing system of the communication satellite may temporarily disable transmit beams to allow endpoint devices to record measurements without satellite interference. If terrestrial cellular coverage is too weak for terrestrial cell service, then the communication satellite can reactivate satellite coverage in the area. On other hand, if the signal strength from a terrestrial base station is sufficient, the communication satellite can back off and direct a more permanent null in the area, e.g., via steps 240 and 250. In still another example, step 210 may include another communication satellite informing the communication satellite about terrestrial cell information that it has obtained. Similarly, in one example, an endpoint device may collect measurements of the wireless environment in an area and can then report to a next terrestrial base station it encounters. The terrestrial cellular base station may then transmit the collected data to a satellite, which may not be the same satellite that serves the area in which the measurements are collected.

In one example, the method 200 may be expanded to include training a MLM that may be implemented at step 230, step 240, and/or step 250. In such example, the method 200 may further include collecting labels/feedback from endpoint devices and/or performance data from network components for sample labeling and for MLM training/retraining, and so forth. In one example, the method 200 may alternative or additionally include at one or more of step 230, step 240, and/or step 250 applying an input vector to a machine learning model (MLM) that is trained to generate/output a coverage hole/pattern and/or an active beam pattern that may result in a coverage hole over an area of potential interference with the terrestrial base station/cell site. For instance, the MLM may be trained to output a selection of such a pattern in response to an input vector comprising one or more of: information from a base/station cell site, information from one or more endpoint devices, and/or information from another source associated with a terrestrial cellular network, the information associated with a footprint/communication coverage zone of the terrestrial cellular base station. In particular, the MLM may be trained/configured to process an input or a set of inputs (e.g., an input vector) including base station location information, endpoint device location information, RSSI values and/or indicators of whether the base station is detected and/or within communication range of an endpoint device, etc., satellite capabilities and/or configuration, and/or other factors, such as a time, a date, a day of the week, a month, etc. In another example, the MLM may be trained/configured to detect an area of potential interference (e.g., at step 240) where the beam pattern selection at step 250 in response thereto may be made via a different mechanism. In one example, the method 200 may be expanded or modified to include steps, functions, and/or operations, or other features described in connection with the example(s) of FIG. 1, or as described elsewhere herein. Thus, these and other modifications are all contemplated within the scope of the present disclosure.

In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1 or described in connection with the example method 200 may be implemented as the processing system 300, such as a communication satellite (e.g., a NTN node) or at least a portion thereof. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for a processing system of a communication satellite applying a transmission beam coverage hole co-located with a first communication coverage zone of a terrestrial cellular base station in response to determining a potential interference between the communication satellite and the terrestrial cellular base station, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 306 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for a processing system of a communication satellite applying a transmission beam coverage hole co-located with a first communication coverage zone of a terrestrial cellular base station in response to determining a potential interference between the communication satellite and the terrestrial cellular base station (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for a processing system of a communication satellite applying a transmission beam coverage hole co-located with a first communication coverage zone of a terrestrial cellular base station in response to determining a potential interference between the communication satellite and the terrestrial cellular base station (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor of a communication satellite, at least one communication from at least one of: a wireless endpoint device or a terrestrial cellular base station that indicates a presence of the terrestrial cellular base station;
identifying, by the processing system, based upon the at least one communication, that a first communication coverage zone of the terrestrial cellular base station is within a second communication coverage zone of the communication satellite;
determining, by the processing system in response to identifying that the first communication coverage zone of the terrestrial cellular base station is within the second communication coverage zone of the communication satellite, a potential interference between the communication satellite and the terrestrial cellular base station; and
applying, by the processing system, a transmission beam coverage hole co-located with the first communication coverage zone of the terrestrial cellular base station, in response to the determining of the potential interference between the communication satellite and the terrestrial cellular base station.

2. The method of claim 1, further comprising:
updating a map of terrestrial cellular base stations in accordance with the at least one communication.

3. The method of claim 2, wherein the communication satellite stores the map, wherein the map is updated in accordance with a communication from a network operator of a cellular network including the terrestrial cellular base station.

4. The method of claim 2, wherein the identifying that the first communication coverage zone of the terrestrial cellular base station is within the second communication coverage zone of the communication satellite is further based on the map of terrestrial cellular base stations.

5. The method of claim 1, wherein the communication satellite is in a non-geostationary orbit, wherein the identifying that first communication coverage zone of the terrestrial cellular base station is within the second communication coverage zone of the communication satellite is further based upon the non-geostationary orbit.

6. The method of claim 5, wherein the identifying that first communication coverage zone of the terrestrial cellular base station is within the second communication coverage zone of the communication satellite comprises:
determining a ground path projection of one or more transmit beams of the communication satellite; and
determining that the ground path projection intersects with the first communication coverage zone.

7. The method of claim 1, wherein the communication satellite and the terrestrial cellular base station utilize a same spectrum.

8. The method of claim 7, wherein the determining of the potential interference includes determining that the communication satellite and the terrestrial cellular base station utilize the same spectrum.

9. The method of claim 1, wherein the applying of the transmission beam coverage hole comprises disabling at least one transmit beam of at least one antenna of the communication satellite.

10. The method of claim 1, wherein the applying of the transmission beam coverage hole comprises adjusting a boresight direction of at least one transmit beam of at least one antenna of the communication satellite.

11. The method of claim 1, wherein the first communication coverage zone of the terrestrial cellular base station is associated with a first time period.

12. The method of claim 11, wherein the at least one communication indicates the first communication coverage zone for the first time period.

13. The method of claim 12, wherein the identifying includes identifying that the first communication coverage zone of the terrestrial cellular base station is to be within the second communication coverage zone of the communication satellite in the first time period.

14. The method of claim 13, wherein the at least one communication indicates the first communication coverage zone for the first time period and a third communication coverage zone of the terrestrial cellular base station for a second time period.

15. The method of claim 14, further comprising:
adjusting, by the processing system, the transmission beam coverage hole during the second time period in accordance with the third communication coverage zone.

16. The method of claim 15, wherein the third communication coverage zone is larger than the first communication coverage zone, wherein the adjusting comprises increasing a size of the transmission beam coverage hole in accordance with the third communication coverage zone.

17. The method of claim 15, wherein the third communication coverage zone is smaller than the first communication coverage zone, wherein the adjusting comprises reducing a size of the transmission beam coverage hole in accordance with the third communication coverage zone.

18. The method of claim 14, wherein the at least one communication comprises a first communication that is obtained from the terrestrial cellular base station and that indicates the first communication coverage zone, wherein the at least one communication further comprises a second communication from the wireless endpoint device, wherein the identifying that the first communication coverage zone of the terrestrial cellular base station is within the second communication coverage zone of the communication satellite includes verifying the first communication coverage zone based on the at least the second communication.

19. A non-transitory computer-readable medium storing instructions which, when executed by a processing system including at least one processor of a communication satellite, cause the processing system to perform operations, the operations comprising:
obtaining at least one communication from at least one of: a wireless endpoint device or a terrestrial cellular base station that indicates a presence of the terrestrial cellular base station;
identifying, based upon the at least one communication, that a first communication coverage zone of the terrestrial cellular base station is within a second communication coverage zone of the communication satellite;
determining, in response to identifying that the first communication coverage zone of the terrestrial cellular base station is within the second communication coverage zone of the communication satellite, a potential interference between the communication satellite and the terrestrial cellular base station; and
applying a transmission beam coverage hole co-located with the first communication coverage zone of the terrestrial cellular base station, in response to the determining of the potential interference between the communication satellite and the terrestrial cellular base station.

20. An apparatus comprising:
a processing system including at least one processor; and
a non-transitory computer-readable medium storing instructions which, when executed by the processing system when deployed in a communication satellite, cause the processing system to perform operations, the operations comprising:
obtaining at least one communication from at least one of: a wireless endpoint device or a terrestrial cellular base station that indicates a presence of the terrestrial cellular base station;
identifying, based upon the at least one communication, that a first communication coverage zone of the terrestrial cellular base station is within a second communication coverage zone of the communication satellite;
determining, in response to identifying that the first communication coverage zone of the terrestrial cellular base station is within the second communication coverage zone of the communication satellite, a potential interference between the communication satellite and the terrestrial cellular base station; and
applying a transmission beam coverage hole co-located with the first communication coverage zone of the terrestrial cellular base station, in response to the determining of the potential interference between the communication satellite and the terrestrial cellular base station.
